(19) United States
(12) Patent Application Publication
(10) Pub. No.: US 2024/0269644 A1
(43) Pub. Date: Aug. 15, 2024

(54) JET IMPINGEMENT REACTOR

(71) Applicant: leon-nanodrugs GmbH, Munich (DE)

(72) Inventor: Frank Stieneker, Munich (DE)

(21) Appl. No.: 18/042,460

(22) PCT Filed: Aug. 22, 2022
(86) PCT No.: PCT/EP2022/073361

§ 371 Date: Feb. 22, 2023

(30) Foreign Application Priority Data
Aug. 23, 2021 (EP) 21192535.9
Mar. 22, 2022 (EP) 22163533.7

(51) Int. Cl. B01J 19/26; B01J 4/00; B01J 14/00; B01J 19/02; C01F 11/46

(52) U.S. Cl. CPC B01J 19/26; B01J 4/002; B01J 14/00; B01J 19/02; C01F 11/462; B01J 2204/002; B01J 2219/0295; B01J 2219/1942; C01P 2004/64

(57) ABSTRACT

A jet impingement reactor having a small, spheroidal reaction chamber is provided. The reaction chamber exhibits a first and a second fluid inlet arranged at opposite positions of the reaction chamber such as to point at one another, and wherein each of the first and the second fluid inlet comprises a nozzle. The distance between the nozzles is the same or smaller than the diameter of the reaction chamber along the first central axis. Preferably, the nozzles are comprised in fluid inlet connectors that are reversibly insertable into the wall of the reaction chamber such as to provide the first and the second fluid inlet. The invention further provides a method of mixing two fluids based on jet impingement using the reactor according to the invention.

### BACKGROUND OF THE INVENTION

Jet impingement reactors are fluid reactors for mixing fluids or for generating particulate fluids by collision. They can, for example, be used for the production of nanoparticle fluids incorporating poorly water-soluble active ingredients. The function of these reactors is based on the use of two fluid streams, at least one of which typically contains the active ingredient, that are injected into a reactor cavity and collide at a turbulent mixing zone, thereby creating the nanoparticles. One of the main principles used in connection with the jet impingement reactors is the solvent/non-solvent precipitation in which a first fluid comprising the active ingredient dissolved in a suitable solvent is contacted with a non-solvent or antisolvent under defined conditions results in the precipitation of the nanoparticles containing the active ingredient. In case one of the solvents contains a lipid, lipid nanoparticles can be produced with help of the jet impingement reactors which may, for example, be subsequently loaded with a biologically active compound, e.g., by pH shift.

Jet impingement reactors comprise a reaction chamber having two fluid inlets with nozzles that allow the two fluids to be injected into the reaction chamber with a pressure that is typically higher than ambient pressure. Through the first and the second fluid inlet, two streams are injected such as to meet inside the reaction chamber and form the collision or mixing zone. An outlet for obtaining the resulting nanoparticle suspension is also provided.

One example for a jet impingement reactor is the microjet reactor as disclosed in EP 1165224 B1. Such a microjet reactor has at least two nozzles or pinholes located opposite one another, each with an associated pump and feed line for directing a liquid towards a common collision point in a reaction chamber enclosed by a reactor housing. The reaction chamber comprises two bores that cross each other and yield in a small cavity in which two fluids collide, possibly without contacting the walls of this cavity. While one of the bores accommodates the two fluid inlets, the second bore accommodates a further opening in the reactor housing through which a gas, an evaporating liquid, a cooling liquid, or a cooling gas can be introduced to maintain the gas atmosphere in the reaction chamber or for cooling. A further opening at the other end of the second bore is provided for removing the resulting products and excess gas from the reactor. If a solvent/non-solvent precipitation is carried out in such a microjet reactor, a dispersion of precipitated particles is obtained. This reactor requires as a third fluid an external source of a gas or cooling liquid. However, the inventors have found that this setup is also associated with problems and disadvantages, such as foaming caused by the gas, or undesired accumulation of product in the gas inlet.

WO 2018/234217 A1 discloses another jet impingement reactor having a housing which encloses a reaction chamber, a first fluid nozzle and a second fluid nozzle oriented in a collinear manner. The second nozzle is located directly opposite the first fluid nozzle in the jet direction of the nozzles. The nozzles reach into the reaction chamber and form a collision zone in form of a disk between each other. This reactor type has at least one rinsing fluid inlet arranged on the side of the first fluid nozzle and at least one product outlet arranged on the side of the second fluid nozzle and can be used for continuous preparation of the particulate fluids. Additionally, rinsing fluid-conducting structures are designed as parallel channels on a side of the first fluid nozzle that produce a rinsing fluid flow directed in the jet direction of the first fluid nozzle and that lead the rinsing fluid in the direction of the collision disk causing a slight deformation of the collision disk. This causes the particles present in the formed nanoparticulate fluid of the collision disk to be conveyed away from the collision zone. Thus, the production process, when carried out in the reactor as disclosed in WO 2018/234217 A1 depends on the presence of the rinsing fluid-conducting structures and of a rinsing fluid.

The quality and reproducibility of the resulting nanoparticle fluids depend, among others, on the protocol for the method of production as well on the precision of the reactor. The protocol of the method can define different parameters, like e.g. the volume flow rate of the fluid streams that are injected though the nozzles, the ratio of these flow rates, the concentration of the ingredients dissolved in the streams, or the temperature settings. These parameters can also be influenced by the reactor itself. The nozzle size, for example, has an influence on the flow rate of streams since its diameter allows only a certain amount of fluid passing the nozzle, depending on the respective pressure of the stream.

The appropriate adaptation of the parameters for production of the nanoparticles and the choice of the appropriate reactor is always a challenge in product and process development or in upscaling processes.

It is also known that the particle size distribution as well as the reproducibility of the results depends on the accurate setup of the reactor, in particular of the nozzles, and on the precise control of the fluid streams. For achieving further improvements with respect to the products' particle size, particle size distribution or other quality parameters, improved jet impingement reactors that allow better control of the process parameters are needed.

Thus, there is a need for systems and methods that yield desirable particle size distributions, morphology and that reduce the risk of undesirable side reactions. Still further, a need remains for systems and methods that can be used continuously and for the production of high amounts of particulate fluids and that are simple in their setup in order to achieve cost effective and uncomplicated production processes that are reliable in terms of reproducibility, and flexible when product or process development or upscaling of established production processes is conducted. Another object is to provide a jet impingement reactor that is easy to clean, and that is versatile in process development. A further object is to overcome one or more disadvantages of jet impingement reactors and related methods proposed in the prior art. These needs and objects are addressed by the invention disclosed herein.

### SUMMARY OF THE INVENTION

In one aspect, the invention provides a jet impingement reactor according to the main claim below. In particular, the jet impingement reactor comprises a reaction chamber defined by an interior surface of a reaction chamber wall, wherein the reaction chamber has a substantially spheroidal overall shape, as described in more detail below. The reaction chamber comprises (a) a first and a second fluid inlet, wherein the first and the second fluid inlet are arranged at opposite positions of a first central axis of the reaction chamber such as to point at one another, and wherein each of the first and the second fluid inlet comprises a nozzle; and (b) a fluid outlet arranged at a third position, said third position being located on a second central axis of said chamber, the second central axis being perpendicular to the first central axis. Moreover, the distance between the nozzle of the first fluid inlet and the nozzle of the second fluid inlet is the same or smaller than the diameter of the reaction chamber along the first central axis.

In preferred embodiments, each nozzle has a downstream end that substantially aligns with the interior surface of the chamber wall. Moreover, the reaction chamber is preferably free of further inlet or outlet openings. According to a further preference, each of the first and the second fluid inlet is provided by a fluid inlet connector having an upstream end, a downstream end holding the nozzle of the first or second fluid inlet, and a fluid conduit for conducting a fluid from the upstream end to the downstream end, wherein the downstream end of each fluid inlet connector is reversibly insertable into the chamber wall such as to provide the first and the second fluid inlet.

In a further aspect, the invention provides a method for mixing two fluids; the method comprises the steps of (i) providing the jet impingement reactor according to the invention; (ii) directing a first fluid stream through the first fluid inlet into the reaction chamber; (iii) directing a second fluid stream through the second fluid inlet into the reaction chamber such as to collide with the first fluid stream at an angle of about 180°.

In one of the preferred embodiments, the orifice of the first nozzle is larger than the orifice of the second nozzle and/or the flow rate of the first fluid is larger than the flow rate of the second fluid, and wherein the pressure of the first fluid and of the second fluid may be adapted such as to cause the first fluid stream and the second fluid stream to have substantially the same kinetic energy when entering the reaction chamber.

In a further aspect, the invention relates to a method for making the jet impingement reactor by injection moulding. In one embodiment, the jet impingement reactor, or at least the reactor wall, may be made from a thermoplastic polymer by injection moulding, wherein prefabricated inlet nozzles consisting of a hard, non-thermoplastic material such as metal, glass or ceramic are inserted into the mould during the injection moulding process, or wherein mechanical or laser drilling is used to manufacture the nozzles on both sides of the reactor.

### DESCRIPTION OF THE DRAWINGS

FIG. 1, which is not to scale, depicts a jet impingement reactor (1) according to one embodiment of the invention. The reaction chamber (6) defined by the interior surface (2) of the chamber wall (3) is substantially spherical, except for the two fluid inlets (4) and the fluid outlet (7). The fluid inlets (4) are arranged at opposite positions on a first central axis (x) of the reaction chamber (6) and point at one another. Each of the fluid inlets (4) comprises a nozzle (5), which is a plain orifice nozzle in this embodiment. The fluid outlet (7) is positioned on a second central axis (y) which is perpendicular to the first central axis (x). The distance (d) between the two nozzles (4) is substantially the same as the diameter of the spherical reaction chamber (6).

FIG. 2 depicts a fluid inlet connector (10) according to one embodiment of the invention. The connector (10) has an upstream end (11), a downstream end (12) holding a nozzle (13) at a downstream position of the downstream end (12), and a fluid conduit (14) for conducting a fluid from the upstream end (11) to the downstream end (12). The fluid inlet connector (10) is designed to provide a fluid inlet for a jet impingement reactor (not shown) according to the invention, and to be reversibly insertable into the wall such of such reactor. The figure is not to scale.

FIG. 3, which is also not drawn to scale, depicts a fluid inlet connector (20) according to another embodiment of the invention. Also, this connector (20) is designed to be reversibly insertable into the wall of a jet impingement reactor (not shown) according to the invention, such as to provide a fluid inlet. It has an upstream end (21), a downstream end (22) holding a nozzle (23) at a downstream position of the downstream end (22), and a fluid conduit (24) for conducting a fluid from the upstream end (21) to the downstream end (22).

FIG. 4 is a graphical depiction of the particle size (Z-average diameter, nm) and polydispersity (PDI) characterized for the lipid nanoparticles encapsulating poly(A) obtained as described in Example 3, at tested total flow rates of 1 mL/min, 5 mL/min, 15 mL/min, 40 mL/min and 280 mL/min. ‘300/300-5-2’ corresponds characterization of the particles produced with a jet impingement reactor provided with a reactor chamber with a diameter of 5 mm, and with an 2-mm outlet, and a pair of exchangeable fluid connectors each having a nozzle with an orifice diameter of 300 nm. ‘200/100-2-1’ corresponds to characterization of the particles produced with a jet impingement reactor provided with a reactor chamber with a diameter of 2 mm, and with a 1-mm outlet, and a pair of exchangeable fluid connectors having nozzles with, respectively for the first fluid and second fluid, an orifice diameter of 200 μm and 100 μm. ‘Tee’ corresponds to the characterization of the particles produced using a Tee-piece (control).

FIG. 5 is a graphical depiction of the encapsulation efficiency (EE %) of poly(A), as determined for the lipid nanoparticles prepared using the different reactor configurations as described in Example 3 and FIG. 4.

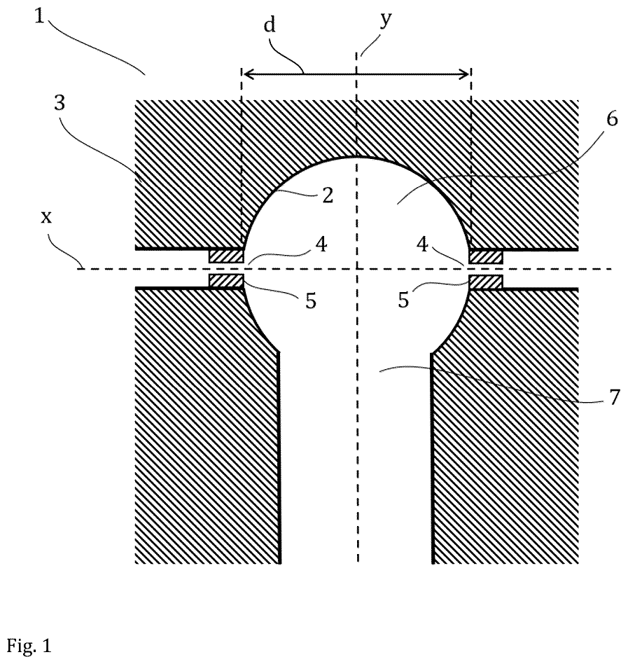

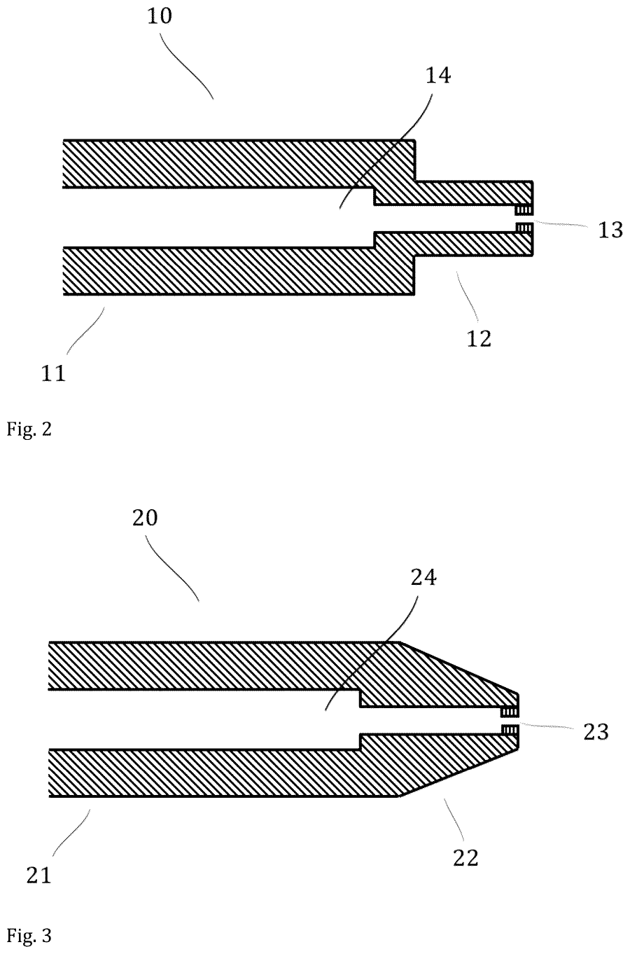

### DETAILED DESCRIPTION OF THE INVENTION

In one aspect, the invention provides a jet impingement reactor, in particular a jet impingement reactor that comprises a reaction chamber defined by an interior surface of a reaction chamber wall which has a substantially spheroidal overall shape, as described in more detail below. The reaction chamber is further characterised in that it comprises (a) a first and a second fluid inlet, wherein the first and the second fluid inlet are arranged at opposite positions of a first central axis of the reaction chamber such as to point at one another, and wherein each of the first and the second fluid inlet comprises a nozzle; and (b) a fluid outlet arranged at a third position, said third position being located on a second central axis of said chamber, the second central axis being perpendicular to the first central axis. Moreover, the distance between the nozzle of the first fluid inlet and the nozzle of the second fluid inlet is the same or smaller than the diameter of the reaction chamber along the first central axis.

The inventors have found that substantial improvements over conventional jet reactors are achieved by the reactor of the invention, in particular based on the substantially spheroidal overall shape of the reaction chamber and its small size in particular as reflected by a relatively short distance between the fluid inlet nozzles. Without wishing to be bound by theory, it is believed that the spheroidal overall shape eliminates some of the detrimental effects of irregularly shaped reaction chambers known in the art that have internal angles, edges or corners, and the associated dead volume zones. The small size and minimised distance between the fluid inlet nozzles is believed to intensify the turbulent mixing of fluids in the chamber and facilitate the proper alignment of the nozzles on the same axis, such as to achieve a frontal collision of the two fluids that are injected into the chamber by the nozzles.

As used herein, a substantially spheroidal overall shape means that at least the larger part of reaction chamber as defined by the internal surface of the chamber wall has the shape of a sphere or is similar to a sphere. For example, the spheroid may be shaped such that some of its cross sections are ellipses. In one preferred embodiment, all parts or portions of the reaction chamber or of the interior surface of the chamber wall except for those portions that hold or define an inlet or an outlet opening are substantially spheroidal, or even spherical.

In case the outlet opening, which is typical relatively large in diameter compared to the diameter of the nozzles or inlet openings, is understood as a deviation from the otherwise spherical shape of the reaction chamber, the shape of the reaction chamber may also be described as a spherical cap, also referred to as a spherical dome. In a preferred embodiment, such spherical cap has a height, a basis, and a radius along the first central axis (i.e. on which the two fluid inlets are positioned), wherein the height is larger than said radius, and wherein the basis is defined by the fluid outlet. In other words, the spherical dome formed by the reaction chamber is larger in volume than a corresponding hemisphere, which also means that diameter of the outlet opening is smaller than the largest diameter of the reaction chamber. In a specific embodiment, the height of the dome is in the range of about 110% to about 170% of the radius. For example, the height may be about 120% to about 160% of the radius, such as about 120%, about 130%, about 140%, about 150%, or about 160% of the radius.

Another preferred feature of the reactor relates to the arrangement of the nozzles. As mentioned, each of the first and the second fluid inlet comprises a nozzle, and in the assembled state of the reactor, the distance between the nozzle of the first fluid inlet and the nozzle of the second fluid inlet is the same or smaller than the diameter of the reaction chamber along the first central axis. This is in contrast to some jet reactors known in the art which have nozzles that are retracted. In a preferred embodiment of the invention, the nozzles—more precisely their downstream ends—are neither retracted nor do they protrude into the reaction chamber, but they are substantially aligned with the interior surface of the reaction chamber wall.

It is further preferred that the reaction chamber is provided with a rather small internal volume which would also correspond to a small distance between the nozzles if arranged according to the preferences explained above. As used herein, the distance between the first nozzle and the second nozzle should be understood as the distance between the downstream ends (i.e., the ends of the nozzles that point to the centre of the reaction chamber). Preferred reaction chamber volumes are below about 0.5 mL, and preferred distances between the nozzles are below about 7 mm. In one specifically preferred embodiment, the reaction chamber has a volume of not more than about 0.25 mL and the distance between the nozzle of the first fluid inlet and the nozzle of the second fluid inlet is not more than 5 mm. In further preferred embodiments, the volume of the reaction chamber is not more than about 0.2 mL, for example about 0.15 mL, and the distance between the two nozzles is not more than about 4 mm. Still smaller dimensions may also be useful, such as 1 mm, 2 mm, or 3 mm. In embodiments where the distance between the first nozzle and second nozzle is the same as the diameter of the reaction chamber along the first central axis, the distance between the nozzles such as described in the embodiments herein above would correspond also to the diameter of the chamber. For clarity, it should be noted that for the purpose of providing these preferences with respect to the volume of the reaction chamber, the respective values have been calculated under the assumption that the reaction chamber has a substantially spherical shape irrespective of the outlet opening. In other words, the outlet opening has not been interpreted as forming the base of a spherical cap that is smaller in volume than the sphere that it is derived from. If the outlet opening were to be understood as being planar such as to form the base of a spherical segment that represents the volume of the reaction chamber, the values in mL provided above should be adapted accordingly, taking the dimensions of the outlet opening into consideration.

In a further particularly preferred embodiment, the reaction chamber is free of other inlet or outlet openings. In other words, the first and a second fluid inlet and the fluid outlet represent the only openings of the reaction chamber that are provided in the chamber wall. This is also in contrast to some known jet impingement reactors which exhibit one or more additional inlets, such as an inlet for a gas to be introduced to the reaction chamber or an outlet for degassing purposes. However, as the inventors have found, such additional inlets or outlets may also negatively interfere with the impingement process and result in uncontrolled precipitation or the building up of contamination in such additional openings, and that a reactor according to the invention brings about the advantage of better control over the interaction and mixing of the first fluid with the second fluid, improved cleanability and increased batch-to-batch consistency.

As used herein, a reactor having a reaction chamber with one or more additional inlet or outlet openings that are inactivated by a closure mechanism should also be understood a reactor whose reaction chamber has no further inlet or outlet opening beyond the two essentially required inlet openings for the first and the second fluid and the outlet opening for the fluid that results from the mixing (and/or reaction) of the first and the second fluid in the reaction chamber.

In accordance with the basic concept of a jet impingement reactor, the reactor of the invention should preferably be configured and/or arranged such as to direct a first fluid and a second fluid into the reaction chamber in such a way that the two fluids impinge on, or collide frontally, with one another. This is particularly relevant for a precise positioning and orientation of the nozzles that are comprised in the two fluid inlets. In a preferred embodiment, accordingly, the jet impingement reactor is characterised in that the nozzles of the first and second fluid inlet are arranged such as to direct a first and a second fluid stream along the first central axis towards the centre of the chamber and to allow the first fluid stream and the second fluid stream to collide at an angle of about 180°. As used herein, the collision at an angle of about 180° may also be referred to as a frontal collision. In this context, the expression “about” means that the actual angle is sufficiently close to 180° to ensure that the collision of the first liquid stream and the second liquid stream results in a rapid and highly turbulent fluid flow in the mixing zone, such that thorough mixing takes place within an extremely short time, e.g., typically within a matter of milliseconds.

As will be understood by the skilled person, and as further exemplified and described in the various embodiments relating to the methods of using the impingement reactor as described herein and below, the reactor of the invention is configured and/or arranged for the mixing of two fluids with one another, namely the mixing of a first and a second fluid by means of a frontal collision of a stream of a first fluid with a stream of a second fluid, the second fluid being different from, or not the same as the first fluid.

Thus, the reaction chamber of the jet impingement reactor, as described in any one or combination of its embodiments herein, may comprise of a first fluid inlet, through which a stream of a first fluid is directed, and a second fluid inlet, through which a stream of a second fluid is directed, the second fluid being different from, or not the same as the first fluid, wherein said first and the second fluid inlet are arranged at opposite positions of a first central axis of the reaction chamber such as to point at one another; wherein each of the first and the second fluid inlet comprises a nozzle, wherein the nozzles are arranged such as to direct a stream of the first fluid (i.e. the first fluid stream) and a stream of a second fluid (i.e. second fluid stream) along the first central axis towards the centre of the chamber and to allow the first fluid stream and the second fluid stream to collide at an angle of about 180°. In another particularly advantageous embodiment, the jet impingement reactor of the invention is equipped with exchangeable nozzles. This will speed up product and process development efforts as it allows a quick screening of process parameters using the same reactor. This is different from prior art reactors which typically have non-removable or non-replaceable nozzles, i.e., nozzles that are glued, welded, crimped or thermofitted in such a way that they cannot be disconnected from the reactor in a non-destructive manner, so that the testing of certain process parameters, in particular the testing of different nozzle diameters, would require the use of several reactors within the respective series of experiments. As used herein, a nozzle diameter should be understood as the internal diameter of the nozzle opening, which may also be referred to as pinhole size or diameter in case the nozzle is a plain orifice nozzle. In other words, this embodiment brings about a substantially increased versatility of the reactor.

In one embodiment, each of the first and the second fluid inlet is provided by a fluid inlet connector having an upstream end, a downstream end holding the nozzle of the first or second fluid inlet, and a fluid conduit for conducting a fluid from the upstream end to the downstream end; wherein the downstream end of each fluid inlet connector is reversibly insertable into the chamber wall such as to provide the first and the second fluid inlet. According to this embodiment, the nozzles are exchangeable in that reversibly insertable inlet connectors holding the nozzles are provided. The nozzles may be firmly affixed to the exchangeable connectors. As used herein, an inlet connector (or fluid inlet connector) may be any piece having an upstream end and a downstream end and an internal fluid conduit configured to provide a fluidic connection between the upstream end and the downstream end.

A further advantage of such reactor configuration with exchangeable fluid inlet connectors (and thereby exchangeable nozzles) is the reactor exhibits better cleanability and a reduced cycle time.

In one embodiment, the fluid inlet connectors are affixed to the chamber wall by means of a releasable compression fitting. For example, the fluid inlet connectors that provides the first and/or the second fluid inlet is affixed to the chamber wall by means of a single ferrule fitting or a double ferrule fitting. Other tight fittings that are capable of preventing leakage under high pressures are also useful to the extent that they are releasable.

In one preferred embodiment, the reactor comprises a fluid inlet connector that has (i) an upstream segment comprising the upstream end of the fluid inlet connector and an upstream portion of the fluid conduit; and (ii) a downstream segment comprising the downstream end of the fluid inlet connector with the nozzle and a downstream portion of the fluid conduit, wherein the diameter of the upstream portion of the fluid conduit is larger than the diameter of the downstream portion of the fluid conduit. In this context, the diameter should be understood as the internal diameter.

The downstream portion may be shaped as, or provided by, a capillary tube whose diameter is substantially smaller than that of the upstream portion. For example, in one embodiment, the diameter of the downstream portion is not larger than half the diameter of the upstream portion. In another embodiment, the diameter of the downstream portion is about 40% of the diameter of the upstream portion or less. Optionally, the upstream portion may be substantially longer than the downstream portion. For example, the ratio of the length of the upstream portion to the length of the downstream portion may be 5:1 or higher, or even 8:1 or higher.

In one specific embodiment, the downstream end of the fluid inlet connector is externally cone-shaped, and the chamber wall exhibits a corresponding void that is also cone-shaped and dimensioned such as to receive the downstream end of the fluid inlet connector. Using this configuration facilitates the insertion of the fluid inlet connector into the reactor and at the same time the proper alignment of the respective nozzle on the first central axis as described above. Preferably, the reactor is equipped with two fluid inlet connectors having basically the same overall configuration, except that their nozzles may have different diameters.

The fluid inlet connectors as described herein represent an aspect of the present invention.

The nozzles may be of any type or geometry that allows the injection of the first and the second fluid into the reaction chamber in the form of a fluid stream, using an appropriate pressure. Useful pressure ranges are generally known to the skilled person.

In one of the preferred embodiments, the nozzle of the first and/or the second fluid inlet is a plain-orifice nozzle. For this embodiment, it is further preferred that both nozzles are plain-orifice nozzles. As used herein, a plain-orifice nozzle is a nozzle that characterised by a simple orifice that essentially has the shape of a simple (i.e. substantially cylindrical) through-hole, which may in view of its small dimensions also referred to as pinhole. Alternatively, the nozzle may also be provided as a shaped-orifice nozzle, as long as the selected shape results in the generation of a fluid stream that is capable of frontally colliding with a second fluid stream in the reaction chamber at the respective working pressures.

If a plain-orifice nozzle is used, such nozzle may be provided as a piece made of a particularly hard material, such as sapphire, ruby, diamond, ceramic, glass-ceramic, glass (such as borosilicate glass) or metal, such as steel, e.g. stainless steel. In the case of steel, it is preferred that a steel quality having a high hardness and low abrasiveness is used, such as high-speed steel (HSS), which is an alloy steel containing carbide-forming elements such as tungsten, molybdenum, chromium, vanadium, and cobalt, the total amount of alloy elements typically being in the range of about 10-25 wt. %, or tungsten steel, also referred to as hard alloy, in which tungsten and cobalt are the main alloy elements.

If sapphire, ruby or diamond nozzles are used, these may be prefabricated, inserted into the downstream end of the downstream portion of the fluid inlet connector and affixed, e.g. by crimping. The nozzles' tolerances that depend on the prefabrication methods should be taken into consideration. If nozzles of steel are used, it is useful to prepare the entire fluid inlet connector or at least the downstream portion thereof from the respective steel quality and then introduce the required orifices. In this manner, the alignment of the nozzles with the first central axis may be further improved.

The diameters of the nozzles, i.e. of the orifices of the nozzles, are typically in the range of below about 1 mm. As process development in the field of pharmaceutics often involves the use of very costly materials, in particular in the development of nanoparticular forms of novel chemical entities, new biological drugs, highly specialised colloidal carrier systems for advanced therapeutics and the like, the volumes of liquids used for process development should be minimised. This is best achieved, inter alia, with even smaller nozzles, such as nozzles having orifices of 0.5 mm or less in diameter.

Accordingly, it is one of the preferred embodiments of the invention that a jet impingement reactor as described above is characterised in that the nozzle of the first fluid inlet has a first orifice diameter and the nozzle of the second fluid inlet has a second orifice diameter, and in that the first orifice diameter and/or the second orifice diameter are in the range of 20 μm to 500 μm. Preferably, both the first orifice diameter and the second orifice diameter are in the range of 20 μm to 500 μm, or in the range of about 50 μm to 500 μm. Also preferred are reactor configurations in which at least one of the orifice diameters is about 500 μm, about 400 μm, about 300 μm, about 200 μm, about 100 μm, about 50 μm, or about 20 μm, respectively. Even smaller diameters, e.g. below 20 μm, may be considered.

In one specific embodiment, the diameters of the first and the second nozzle (i.e. nozzle orifice) are the same, such as about 300 μm, about 200 μm, about 100 μm. Such configuration seems to work well for some but certainly not all product applications. The inventors have found that for many processes based on jet impingement technology best results are achieved with a reactor according to the invention that has two nozzles that differ in size. In other words, the first orifice diameter is larger than the second orifice diameter, according to this further preferred embodiment Such asymmetric nozzle configuration may be advantageous in various ways: For example, it may be used to minimise the introduction of a solvent that is required for processing purposes but undesirable in the final product. It may also be used for the generation of two liquid streams that have different flow rates but similar kinetic energy as they are injected through the nozzles into the reaction chamber where they collide. The possibility to work with different nozzle diameters using one and the same reactor, in particular a reactor having exchangeable nozzles or fluid inlet connectors which may readily be replaced, substantially increases the versatility of the reactor according to the present invention.

In one embodiment, the diameter of the first nozzle (i.e. its orifice) is at least 20% larger than that of the second nozzle. In a further embodiment, the ratio of the first orifice diameter to the second orifice diameter is from about 1.2 to about 5. For example, the following nozzle pairs may be used, wherein the first value represents the approximate diameter of the first orifice and the second value the approximate diameter of the second orifice: 100 μm and 50 μm; 200 μm and 100 μm; 200 μm and 50 μm; 300 μm and 200 μm; 300 μm and 100 μm; 300 μm and 50 μm; 400 μm and 300 μm; 400 μm and 200 μm; 400 μm and 100 μm; 400 μm and 50 μm; 500 μm and 400 μm; 500 μm and 300 μm; 500 μm and 200 μm; 500 μm and 100 μm; 500 μm and 50 μm. Again, these pairs are non-limiting examples, and other orifice diameter combinations may also be useful, depending on the specific product or process.

Moreover, the inventors have found that it is useful to observe certain dimensional relationships in the configuration of the reactor, in particular when small nozzles are used. As already mentioned, it is preferred that the reaction chamber is small, generally speaking. It was also found that it is useful for some processes to provide the reactor with a reaction chamber diameter that is not more than 100 times the diameter of the nozzle orifices or, if nozzles with different sizes are used, with a chamber diameter that is not more than about 100 times the diameter of the larger nozzle's orifice diameter. For example, if the larger nozzle has an orifice diameter of 100 μm, it is preferred according to this specific embodiment that the diameter of the reaction chamber is about 10 mm or less. In one embodiment, where the nozzle, or larger nozzle has an orifice diameter between 200 to 300 μm, the diameter of the reaction chamber along the first central axis is preferably in the range of 2 to 5 mm.

In a related embodiment, the ratio of the diameter of the reaction chamber along the first central axis to the first orifice diameter is in the range from 6 to 60. For example, if the diameter of the first orifice is about 200 μm, the diameter of the reaction chamber along the first central axis would be in the range from about 1.2 mm to about 12 mm, according to this specific embodiment. However, reactors equipped with larger nozzles may require other dimensional considerations.

According to a further related embodiment, the ratio of the diameter of the reaction chamber along the first central axis to the diameter of the fluid outlet is in the range of about 1.2 to about 3. For example, a reaction chamber having a diameter of about 3 mm would have an outlet diameter of about 1 mm to about 2.5 mm, according to this specific embodiment. In one preferred embodiment, the fluid outlet diameter is about 1 to 2 mm.

When selecting the outlet diameter, also the nozzle orifice diameters should be taken into consideration. For example, small nozzle sizes (i.e. orifices) such as below 100 μm should be combined with a small fluid outlet diameter, such as below 1 mm, in order to ensure that the pressure in the reaction chamber is sufficiently high to support turbulence and rapid mixing of the two fluids. For example, when using two nozzles with orifices of 50 μm, a fluid outlet diameter of 0.5 mm may be used. Based on the disclosure of the invention and the guidance provided above, it would be clear for the skilled person that further variations of the dimensional factors may also be useful to accommodate certain product or process requirements.

With respect to the material of the reactor, in particular the material of the chamber wall, various types of sufficiently hard and wear-resistant materials may be used. In some of the preferred embodiments, the reaction chamber wall (3) is made of a material selected from metal, glass, glass-ceramics, ceramics, and thermoplastic polymers.

An example of a particularly useful metal is stainless steel. In one of the preferred embodiments, therefore, the reactor of the invention comprises a reaction chamber wall made of stainless steel. Carbides and coated alloys may also be used, depending on the type of product for whose manufacture the reactor is to be used. Moreover, it is also preferred that the interior surface of the chamber wall exhibits a smooth finish. A smooth finish may be characterised by a low Ra value that expresses the surface roughness. The Ra value represents the arithmetic mean roughness value from the amounts of all values when measuring the surface along a surface profile. According to one of the preferred embodiments, the interior surface of the reaction chamber wall exhibits a surface roughness of not more than 0.8 Ra, wherein Ra is determined according to ISO 4287:1997.

In an alternative but also preferred embodiment, the jet impingement reactor comprises a reaction chamber wall made of a thermoplastic polymer, or a material comprising a thermoplastic polymer, such as a mixture of thermoplastic polymers or a mixture of a thermoplastic polymer and an additive, such as colouring agents, antioxidants, antistatics, glass fibres and the like. An advantage of a reaction chamber wall made of a thermoplastic polymer or materials based on a thermoplastic polymer is that the reactor may potentially be manufactured by injection moulding, which is a very cost-effective manufacturing method. Examples of potentially suitable thermoplastic polymers include, without limitation, polytetrafluoroethylene (PTFE), polyamide, polycarbonate (PC), polyether ether ketone (PEEK), polyethylene (PE), polypropylene (PP), polystyrol (PS), acrylonitrile butadiene styrene (ABS), polyoxymethylene (POM), polyphenylsulfone (PPSF or PPSU), and polyetherimide (PEI). In one of the embodiments, the thermoplastic polymer is selected from PTFE and PEEK.

In one embodiment, the jet impingement reactor comprises (i) a reaction chamber wall made of, or comprising, a thermoplastic polymer, and (ii) fluid inlet nozzles (i.e. the nozzles of the first and the second fluid inlet). Optionally, said fluid inlet nozzles may be made of a material selected from metal, glass, glass-ceramic, and ceramic. An advantage of such embodiment is that it combines nozzles having a high degree of hardness and strength while at the same time allowing the main body of the reactor, i.e. the reaction chamber wall, to be cost-effectively manufactured by injection moulding. In these embodiments, the fluid inlet nozzles may either be arranged in an exchangeable or non-exchangeable manner with respect to the reaction chamber wall. If designed to be exchangeable, this results in the advantage that the jet impingement reactor is versatile and can be used with a high degree of flexibility for various products and processes. On the other hand, if designed to be non-exchangeable, this may bring about the advantage of very cost-effective manufacture in that nozzles may be prefabricated and then inserted into the respective mould for, or during, the injection moulding process by which the main body of the reactor, i.e. at least the reaction chamber wall, is produced. In an alternative embodiment, the jet impingement reactor comprises (i) a reaction chamber wall made of, or comprising a thermoplastic polymer, and (ii) fluid nozzles (i.e. nozzles of the first and second fluid inlet) which are obtained, or manufactured by mechanical or laser drilling of the jet impingement reactor, e.g. on at least one or both sides of reactor, or reactor chamber wall.

A further aspect of the invention relates to the manufacture of the jet impingement reactor described above. As mentioned, the reactor—if made of a thermoplastic polymer or of a material comprising, or based on, a thermoplastic polymer, the reactor, or at least its main body comprising the reaction chamber wall, may be prepared by injection moulding. Accordingly, in some preferred embodiments, the jet impingement reactor is made by a method comprising a step of injection moulding of the reaction chamber wall.

In one embodiment, the method for making the jet impingement reactor having (a) a reaction chamber wall made of a thermoplastic polymer and (b) nozzles of the first and second fluid inlets made of a material selected from metal, glass, glass-ceramic, and ceramic, comprises the steps of: (i) providing a mould for shaping the reaction chamber wall; (ii) providing the nozzle of the first fluid inlet and the nozzle of the second fluid inlet (4); (iii) inserting said nozzles into the mould; (iv) melting the thermoplastic polymer; and (v) injecting the molten thermoplastic polymer into the mould.

Examples of potentially suitable thermoplastic polymers which may be used in the context of the present invention have already been disclosed above. Further details regarding the method such as the temperature at which the molten thermoplastic polymer may be injected into the mould depend on the selected material, i.e. the nature of the thermoplastic polymer, and are generally known to those skilled in the art.

In a further aspect, the invention provides a method based on the use of the reactor described in detail above. In particular, the invention discloses a method of mixing two fluids, the method comprising the steps of: (i) providing the jet impingement reactor as described above; (ii) directing a first fluid stream through the first fluid inlet into the reaction chamber; (iii) directing a second fluid stream through the second fluid inlet into the reaction chamber such as to collide with the first fluid stream at an angle of about 180°.

As used herein, a fluid is a liquid or gaseous material that continually flows or deforms when it is subjected to shear stress. Preferably, the two fluids mixed according to the invention are liquid materials, such as liquid solutions, suspensions or emulsions, and most preferably liquid solutions. As used herein, the mixing of the two fluids in the reactor may optionally further involve other physical or chemical changes beyond the mere mixing, such as precipitation, emulsification, complexation, self-assembly, or even chemical reactions; but all these optional processes are triggered by the mixing of the two liquids as achieved by the use of the jet impingement reactor according to the invention.

Operating the reactor under jet impingement conditions typically involves the selection of appropriate nozzle sizes as described above, and the providing of the two fluid streams at a pressure or flow rate that causes the fluids to be injected through the nozzles into the reaction chamber towards its centre where they ideally collide frontally.

If the reactor is configured to have exchangeable fluid inlet connectors that are reversibly insertable into the chamber wall such as to provide the first and the second fluid inlet, the method step of providing the jet impingement reactor may comprise the sub-steps of (i) selecting a first fluid inlet connector having a first nozzle and a second fluid inlet connector having a second nozzle; and (ii) inserting the first fluid inlet connector and the second fluid inlet connector into the chamber wall such as to provide a jet impingement reactor having a first and a second fluid inlet. As explained above, the orifice diameters may differ between the first and the second nozzle.

In one of the preferred embodiments of the method, the first fluid stream comprises a dissolved active ingredient, and the second fluid stream is a non-solvent or antisolvent for the active ingredient, so that the collision and mixing of the two streams in the reaction chamber leads to the precipitation of nanoparticles comprising the active ingredient. In one of the preferred embodiments, the first and the second fluid stream are forced through the respective fluid inlet nozzles at a pressure in the range of about 0.1 to about 120 bar. In this context, and unless the context dictates otherwise, the pressure is expressed as gauge pressure, i.e., the overpressure, or pressure difference to the ambient (atmospheric) pressure that is typically obtained from a pressure gauge that is in fluid connection with the respective fluid to be measured. In a further preferred embodiment, the first and the second fluid stream are forced through the respective fluid inlet nozzles at a pressure in the range of about 1 to about 40 bar.

In a further preferred embodiment, each of the first and the second fluid stream is directed into the reaction chamber at a flow rate in the range of about 1 to 1000 mL/min. In this context, the flow rates are provided for each individual stream, unless indicated otherwise. Other preferred ranges of the flow rate are from about 5 to about 500 mL/min and from about 10 to about 300 mL/min, respectively.

Like the preferences regarding the pressures, the preferred flow rates should also be understood as generally applicable and thus combinable with one another. In other words, there is also an option or even preference for an embodiment of the method in which the first and the second fluid are directed through the respective nozzles into the reaction chamber at a pressure in the range of about 0.1 to about 120 bar, in particular of about 1 to about 40 bar, at a flow rate in the range of about 10 to 300 mL/min.

As described above, according to one of the preferred embodiments of the jet impingement reactor, the two nozzles may differ in pinhole size, i.e., the orifice of the first nozzle may be larger than that of the second nozzle. In a related embodiment, the method of the invention is performed with such reactor equipped with two different nozzles. Alternatively, or in addition, flow rate of the first fluid may be larger than the flow rate of the second fluid. In a further preferred embodiment, the method is characterised in that (i) the orifice of the first nozzle is larger than the orifice of the second nozzle; and/or (ii) the flow rate of the first fluid is larger than the flow rate of the second fluid; and wherein the pressure of the first fluid and of the second fluid is adapted such as to cause the first fluid stream and the second fluid stream to have substantially the same kinetic energy when entering the reaction chamber.

In this context, the kinetic energy may optionally be calculated according to the formula

$${E}_{k} = 1 / 2 * m * {v}^{2}$$

wherein m is the mass of the stream per volume unit and v is the speed of the stream.

The advantage of working with two liquid streams that have a similar or even substantially the same kinetic energy is that the collision point in a spheroidal (i.e. symmetric) reaction chamber is at or close to the centre of the chamber. Thus, it is possible to better control the impingement process and rule out the impact of uncontrolled collision points which may have various unknown or even undesirable effects on the process.

In some further preferred embodiments, the method comprises the use of a first liquid which is an aqueous liquid, and of a second liquid which is an organic liquid. As used herein, an aqueous liquid should be understood as liquid whose predominant solvent or liquid constituent is water. For example, an aqueous liquid may comprise dissolved or suspended solids, but it is nevertheless an aqueous liquid if the major (or most abundant in mass) liquid constituent is water. In other words, an aqueous buffer solution comprising small amounts of ethanol would clearly be an aqueous liquid. In contrast, an organic liquid is a liquid whose predominant solvent or liquid constituent is an organic solvent or a combination of two or more organic solvents.

Again, this preferred embodiment is combinable with other preferences described above. For example, it is also a preferred embodiment to conduct the method of the invention using a first fluid which is an aqueous liquid, a second fluid which is an organic liquid, a first nozzle having a larger orifice than the second nozzle; directing the first fluid and the second fluid through the first nozzle and the second nozzle, respectively, at a flow rate in the range of about 10 to 300 mL/min and at a pressure in the range of 0.1 to 120 bar, in particular in the range of 1 to 40 bar, into the reaction chamber such that the first fluid stream and the second fluid stream collide frontally, i.e., at an angle of about 180°. Preferably, the kinetic energy of the fluid streams is sufficiently similar to cause a collision or impingement of the streams at or near the centre of the reaction chamber.

The invention including some further embodiments, options and preferences are further illustrated by the following examples which should not be understood as limiting the scope of the invention.

### EXAMPLES

### Example 1: Preparation of Barium Sulphate Nanoparticles

A jet impingement reactor according to the invention made of stainless steel was used to prepare barium sulphate nanoparticles. The reactor was equipped with two exchangeable fluid inlet connectors comprising ruby nozzles that were aligned on the same axis such as to point at one another at an angle of approximately 180°. The internal volume of the reaction chamber was about 0.15 mL, and the distance between the nozzles (i.e., between their downstream ends) was about 3 mm.

The reactor was connected to an apparatus providing the containers, tubing, pumps, valves, pressure gauges, thermometers and flow meters required to operate the reactor. The first fluid that was fed to the reactor via the first nozzle was an aqueous solution of barium chloride. The second fluid was sodium sulphate. As known, barium ions and sulphate ions readily precipitate as barium sulphate.

Three sets of process parameters were tested (A, B and C) at a temperature of about 23° C. The parameters are provided in Table 1 below.

TABLE 1

| | Fluid 1 | | | Fluid 2 | | |
|---|---|---|---|---|---|---|
| Set | F [mL/min] | d [μm] | p [bar] | F [mL/min] | d [μm] | p [bar] |
| A | 70 | 200 | 13.0 | 56 | 200 | 8.0 |
| B | 70 | 200 | 14.9 | 62 | 200 | 10.9 |
| C | 70 | 200 | 14.4 | 66 | 200 | 12.4 |

F: Flow rate (volume flow)
d: Diameter of nozzle orifice
p: Pressure (gauge pressure)

In result, it was found that barium sulphate nanoparticles were obtained with all three sets of process parameters.

### Example 2: Characterisation of Barium Sulphate Nanoparticles

The barium sulphate nanoparticles prepared in Example 1 were characterised with respect to their particle sizes and the polydispersity of the particle size distributions. The particle sizes were obtained as z-averages of the hydrodynamic particle diameters using dynamic light scattering (DSL). The respective measurements were performed at room temperature immediately after the batches A, B and C were produced, and repeated after 48 hours of storage at room temperature. The results are provided in Table 2.

TABLE 2

| | t = 0 | | t = 48 h | |
|---|---|---|---|---|
| Set | z ± SD [nm] | PDI ± SD | z ± SD [nm] | PDI ± SD |
| A | 77.5 ± 1.8 | 0.174 ± 0.004 | 77.5 ± 1.8 | 0.174 ± 0.004 |
| B | 93.6 ± 1.7 | 0.156 ± 0.009 | 87.9 ± 2.3 | 0.115 ± 0.004 |
| C | 142.4 ± 1.7 | 0.196 ± 0.009 | 122.7 ± 4.5 | 0.110 ± 0.007 |

z: z-average
SD: standard deviation
PDI: Polydispersity index

The results indicate that the barium sulphate nanoparticles obtained according to the invention were of high quality and sufficiently stable.

### Example 3: Preparation of Poly(A) Lipid Nanoparticles

Jet impingement reactors according to the invention made of stainless steel were used to prepare poly(A)-loaded lipid nanoparticles. Each reactor was equipped with two exchangeable fluid inlet connectors comprising stainless steel (316L) nozzles that were aligned on the same axis such as to point at one another at an angle of approximately 180°, with the distance between the first and second nozzles being the same as the diameter of the reaction chamber along the first central axis.

Jet impingement reactors comprising reaction chambers with diameter along the first central axis of 2 mm and 5 mm were tested. The 2-mm diameter reactor chamber, having an outlet diameter of 1 mm, was provided with a pair of exchangeable fluid inlet connectors, the first fluid inlet connector having a nozzle orifice diameter of 200 μm and the second fluid inlet connector having a nozzle orifice diameter of 100 μm, respectively (asymmetric reactor set-up). The 5-mm diameter reactor chamber, having a 2 mm outlet diameter, was provided with a pair of exchangeable fluid inlet connectors with nozzle orifice diameters of 300 μm for both nozzles of the inlet connectors (symmetrical reactor set-up). As a control, a Tee-piece (PEEK, 0.020″, 500/500 μm) was used.

The preparation of the poly(A)-loaded lipid nanoparticles was tested across different total flow rates (TFR, the sum of the flow rate of the first fluid stream and the second fluid stream), at a constant flow rate ratio of 3:1 with respect to the flow rate of the first fluid, i.e. the aqueous solution to the flow rate of the second fluid, i.e. the organic solution. The composition of the first and second fluids and the tested total flow rates are described in Table 3.

The reactors were connected to apparatus providing the containers, tubing, pumps, valves, pressure gauges, thermometers and flow meters required to operate the reactor. Two apparatus set-ups were used: a lab-scale apparatus, capable of handling ca. batches at volumes of about 1-10 mL and total flow rates of ca. 0.1-60 mL/min, and a pilot-scale apparatus capable of handling larger batch volumes of about 50-1000 mL, and total flow rates of up to 500 mL/min. The reactors were operated using the lab-scale apparatus to test the total flow rates of 1 mL/min, 5 mL/min, 15 mL/min, and 40 mL/min; and operated using the pilot-scale apparatus for the total flow rates of 40 mL/min and 280 mL/min.

TABLE 3

| First fluid | Solution of poly(A)(polyadenylic acid, lyophilized, 700-3500 kDa, | | | | |
|---|---|---|---|---|---|
| | avg. 4831 nucleotides) in 50 mM citrate buffer solution (pH 6) | | | | |
| | Poly(A) concentration: 0.095 mg/mL | | | | |
| Second fluid | Solution of | | | | |
| | (6Z, 9Z, 28Z, 31Z)-heptatriaconta-6,9,28,31-tetraen-19-yl-4- | | | | |
| | (dimethylamino)butanoate; | | | | |
| | cholesterol; | | | | |
| | 1,2-diasteroyl-sn-glycerol-3-phosphocholine (DSPC); and | | | | |
| | (R)-2-3-bis(tetradecycloxy)propyl 1- | | | | |
| | (methoxypoly(ethyleneglycol)2000)propyl carbamate (DMG- | | | | |
| | PEG2000) | | | | |
| | at a ratio, respectively, of 50:38.5:10:1.5 mol % in ethanol. | | | | |
| | Total lipid concentration: 10 mg/mL in ethanol | | | | |
| Total flow rate | 1 | 5 | 15 | 40 | 280 |
| (TFR) | mL/min | mL/min | mL/min | mL/min | mL/min* |

*Tested only for the 5 mm diameter reactor chamber.

The product test samples were diluted to 10% ethanol using 50 mM citrate buffer (pH 6) immediately after sample collection. The diluted samples were subjected to dialysis against PBS buffer (pH 7.4) with moderate magnetic stirring using 3 mL cassettes. Buffer was exchanged twice at 2 h intervals, and then left overnight before characterization by dynamic light scattering (DLS, Stunner) to assess the lipid nanoparticle size and polydispersity index (PDI). Encapsulation efficiency (EE %) was analyzed using a Quant-iT™ RiboGreen™ RNA Assay Kit according to manufacturer's protocols.

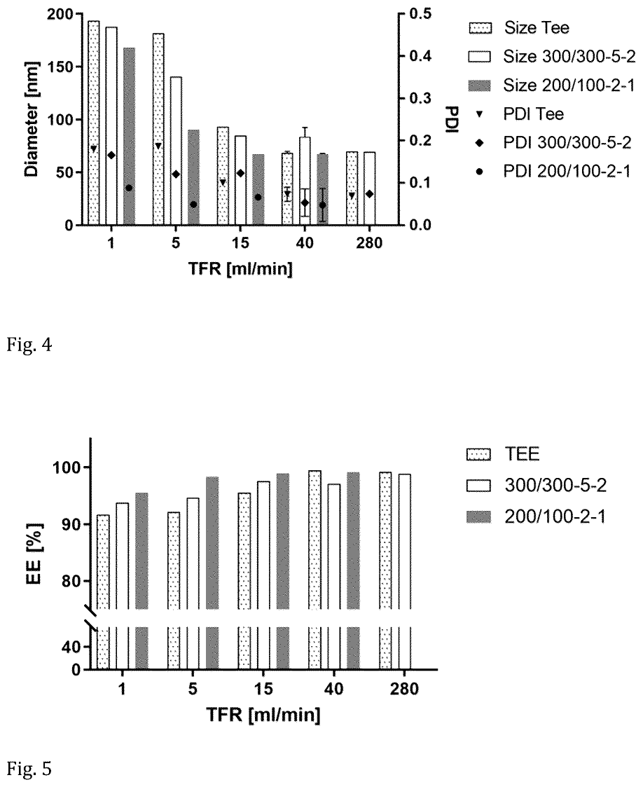

Particle size was found to be consistent across the two jet impingement reactor configurations at the tested total flow rates, and with the T-piece-produced particles. No distinct differences were found between the particles produced on the different apparatus but with same reactor configuration. PDI of the obtained particles was also low, in particular for the jet impingement reactor with the 2 mm-diameter chamber, even at lower total flow rates such as 5 mL/min (see FIG. 4).

High encapsulation efficiency (EE %) of poly(A) was observed for particles prepared from the jet impingement reactors across the tested total flow rates—especially at total flow rates greater than 15 mL/min (see FIG. 5).

In summary, these results indicate that the jet impingement reactor according to the present disclosure produces lipid nanoparticles encapsulating a payload at desirable particle sizes and PDIs, and with very high encapsulation efficiency across the tested configurations and flow rates.

1. A jet impingement reactor comprising a reaction chamber defined by an interior surface of a reaction chamber wall, the reaction chamber having a substantially spheroidal overall shape, said chamber comprising:
(a) a first and a second fluid inlet, wherein the first and the second fluid inlet are arranged at opposite positions on a first central axis of the reaction chamber such as to point at one another, and wherein each of the first and the second fluid inlet comprises a nozzle; and
(b) a fluid outlet arranged at a third position, said third position being located on a second central axis of said chamber, the second central axis being perpendicular to the first central axis;
wherein the distance between the nozzle of the first fluid inlet and the nozzle of the second fluid inlet is the same or smaller than the diameter of the reaction chamber along the first central axis.

2. The jet impingement reactor of claim 1, wherein the nozzle of the first fluid inlet and the nozzle of the second fluid inlet have a downstream end, and wherein the downstream end of each nozzle substantially aligns with the interior surface of the chamber wall, and/or wherein the nozzles are arranged such as to direct a first and a second fluid stream along the first central axis towards the centre of the chamber and to allow the first fluid stream and the second fluid stream to collide at an angle of about 180°.

3. The jet impingement reactor of claim 1, wherein
(i) the reaction chamber has the overall shape of a spherical cap having a height, a basis, and a radius along the first central axis, wherein the height is larger than said radius, the height preferably being from 110% to 170% of said radius, and wherein the basis is defined by the fluid outlet, and/or
(ii) essentially all of the interior surface of the reaction chamber wall is substantially spherical, optionally with the exception of portions of the interior surface that are part of the first and/or second fluid inlet or of the fluid outlet; and/or
(iii) the reaction chamber is free of other inlet or outlet openings.

4. The jet impingement reactor of claim 1, wherein the reaction chamber has a volume of not more than 0.25 mL and the distance between the nozzle of the first fluid inlet and the nozzle of the second fluid inlet is not more than 5 mm.

5. The jet impingement reactor of claim 1, wherein each of the first and the second fluid inlet is provided by a fluid inlet connector having an upstream end, a downstream end holding the nozzle of the first or second fluid inlet, and a fluid conduit for conducting a fluid from the upstream end to the downstream end, and wherein the downstream end of each fluid inlet connector is reversibly insertable into the chamber wall such as to provide the first and the second fluid inlet; wherein the fluid inlet connector that provides the first and/or the second fluid inlet is optionally affixed to the chamber wall by means of a single ferrule fitting or a double ferrule fitting.

6. The jet impingement reactor of claim 5, wherein the fluid inlet connector has
an upstream segment comprising the upstream end of the fluid inlet connector and an upstream portion of the fluid conduit; and
a downstream segment comprising the downstream end of the fluid inlet connector with the nozzle and a downstream portion of the fluid conduit, wherein the diameter of the upstream portion of the fluid conduit is larger than the diameter of the downstream portion of the fluid conduit.

7. The jet impingement reactor of claim 1, wherein the nozzle of the first and/or the second fluid inlet is a plain-orifice nozzle which is optionally made of sapphire, ruby, diamond, ceramic, or steel.

8. The jet impingement reactor of claim 1, wherein the nozzle of the first fluid inlet has a first orifice diameter and the nozzle of the second fluid inlet has a second orifice diameter, wherein the first orifice diameter and/or the second orifice diameter is in the range of 20 μm to 500 μm, and wherein first orifice diameter is optionally larger than the second orifice diameter, the ratio of the first orifice diameter to the second orifice diameter optionally being from 1.2 to 5.

9. The jet impingement reactor of claim 1, wherein the ratio of the diameter of the reaction chamber along the first central axis to the first orifice diameter is in the range from 6 to 60.

10. The jet impingement reactor of claim 1, wherein the ratio of the diameter of the reaction chamber along the first central axis to the diameter of the fluid outlet is in the range of about 1.2 to 3.

11. The jet impingement reactor of claim 1, wherein the interior surface of the reaction chamber wall exhibits a surface roughness of not more than 0.8 Ra, wherein Ra is determined according to ISO 4287:1997.

12. The jet impingement reactor of claim 1, wherein the reaction chamber wall is made of a material selected from metal, glass, glass-ceramic, ceramic, and thermoplastic polymers.

13. The jet impingement reactor of claim 12, wherein the thermoplastic polymer is selected from polytetrafluoroethylene (PTFE), polyamide, polycarbonate (PC), polyether ether ketone (PEEK), polyethylene (PE), polypropylene (PP), polystyrol (PS), acrylonitrile butadiene styrene (ABS), polyoxymethylene (POM), polyphenylsulfone (PPSF or PPSU), and polyetherimide (PEI), in particular from polytetrafluoroethylene (PTFE) and polyether ether ketone (PEEK).

14. The jet impingement reactor of claim 1, wherein the nozzle of the first fluid inlet and the nozzle of the second fluid inlet are made of a material selected from metal, glass, glass-ceramic, and ceramic.

15. A method for making the jet impingement reactor of claim 1, wherein the reaction chamber wall is made of a thermoplastic polymer and the nozzle of the first fluid inlet and the nozzle of the second fluid inlet are made of a material selected from metal, glass, glass-ceramic, and ceramic, wherein the method comprises the steps of:
(i) providing a mould for shaping the reaction chamber wall;
(ii) providing the nozzle of the first fluid inlet and the nozzle of the second fluid inlet;
(iii) inserting the nozzle of the first fluid inlet and the nozzle of the second fluid inlet into the mould;
(iv) melting the thermoplastic polymer; and
(v) injecting the molten thermoplastic polymer into the mould.

16. A method of mixing two fluids, the method comprising the steps of:
(i) providing the jet impingement reactor of claim 1;
(ii) directing a first fluid stream through the first fluid inlet into the reaction chamber;
(iii) directing a second fluid stream through the second fluid inlet into the reaction chamber such as to collide with the first fluid stream at an angle of about 180°.

17. The method of claim 16, wherein each of the first and the second fluid stream is forced through the fluid inlet nozzle at a pressure in the range of 0.1 to 120 bar, and optionally at a pressure in the range of 1 to 40 bar; and wherein optionally each of the first and the second fluid stream is directed into the reaction chamber at a flow rate in the range of about 1 to 1000 mL/min.

18. The method of claim 16, wherein
the orifice of the first nozzle is larger than the orifice of the second nozzle; and/or
the flow rate of the first fluid is larger than the flow rate of the second fluid;
and wherein the pressure of the first fluid and of the second fluid is adapted such as to cause the first fluid stream and the second fluid stream to have substantially the same kinetic energy when entering the reaction chamber, wherein the kinetic energy is optionally calculated according to the formula Eₖ=½*m*v².

19. The method of claim 16, wherein the first fluid is an aqueous liquid, and wherein the second fluid is an organic liquid.
